(19) United States
(12) Patent Application Publication
(10) Pub. No.: US 2014/0078881 A1
(43) Pub. Date: Mar. 20, 2014

(54) Methods and Devices for Transmission of Signals in a Telecommunication System

(71) Applicant: Telefonaktiebolaget L M Ericsson (publ), Stockholm (SE)

(72) Inventor: Miguel Lopez, Solna (SE)

(73) Assignee: Telefonaktiebolaget L M Ericsson (publ), Stockholm (SE)

(21) Appl. No.: 13/880,989

(22) PCT Filed: Mar. 21, 2013
(86) PCT No.: PCT/SE13/50311

§ 371 Date: Apr. 23, 2013

Related U.S. Application Data
(60) Provisional application No. 61/625,172, filed on Apr. 17, 2012.

(51) Int. Cl. H04J 3/16

(52) U.S. Cl. CPC H04J 3/1694
USPC 370/210; 370/336; 375/340

(57) ABSTRACT

Methods and devices for generating and receiving a training sequence in a radio communication network for a user sharing the same transmission slot with other users is provided where multiple users are multiplexed in the same time slot.

A first, original, bit sequence, is repeated and a cyclic prefix and a cyclic postfix is added to the repeated bit sequence thereby forming the training sequence for the user.

### FIELD OF THE INVENTION

The present invention relates to methods and devices for transmission of signals in a telecommunication system.

### BACKGROUND

In order to continue improving the spectral efficiency of GSM/EDGE Global (System for Mobile Communication (GSM)/Enhanced Data for GSM Evolution), there is a need to find effective ways of multiplexing multiple users' signals into a single time slot over a 200 kHz channel while avoiding or minimizing mutual interference among users.

In accordance with a proposal in 3GPP/GERAN (third generation partnership project/GSM EDGE Radio Access Network) a fast feedback channel for Voice over IP is proposed, see GERAN#44 GP-091988 “Fast Feedback Channel” (v1). The idea is to allow the Voice over internet protocol (IP) users to signal the network when there are packets available for transmission. This channel must allow fast feedback and must consume as little bandwidth as possible. To this end, several users are multiplexed into one timeslot by means of time division multiplexing.

Another example is Voice services over Adaptive Multi-user channels on One Slot (VAMOS), in which up to two full rate users are multiplexed in the same time slot. VAMOS is a standardized 3GPP/GSM feature. However, in the uplink, the receiver requires complex multi-user detection since the two user signals are ordinary Gaussian minimum shift keying (GMSK) co-channel interferers.

Due to the scarcity of the electromagnetic spectrum, it is desirable to multiplex more than 2 users into a single time slot, while keeping the receiver complexity low. Moreover, it is desirable to allow the users to employ GMSK modulation. This non-linear modulation technique has very good spectral properties and it is well suited for energy efficient analog Radio Frequency (RF) front ends. Energy efficiency is always important in mobile stations.

Multi-user multiplexing has been standardized in GSM. In the uplink the users transmit using GMSK modulation, and become ordinary co-channel interferers. In the downlink AQPSK modulation is used, see 3GPP Technical Specification TS 45.004 v9.1.0. Note that neither the uplink nor the downlink transmission modes in VAMOS create truly orthogonal sub-channels. In the uplink the users are ordinary co-channel interferers, and the signals are separated in the receiver with the help of their training sequences. The training sequences are such that they have low cross correlation.

Two-layer transmission was standardized recently in GSM (Global System for Mobile communication). The feature is as set out above called VAMOS. Since accurate synchronization and channel estimation are critical for successful decoding, a new set of training sequences was also introduced, see 3GPP TS 45.002 v9.5.0. These training sequences were designed to be orthogonal with the legacy set of training sequences, in the sense that the cross-correlations are small. However, complete orthogonality is not achieved. It seems difficult to increase the number of layers, say to 3 or 4 users, and still be able to perform accurate channel estimation. This is particularly challenging if the receiver has a small number of antennas, say one or two. As an illustration, the Cramer-Rao lower bound of the estimation error for a 5-tap channel estimate is shown in FIGS. 1-3, assuming a single antenna receiver. This is a theoretical bound on the variance of the estimation error, see Steven M. Kay, “Fundamentals of Statistical Signal Processing, Estimation Theory”, Prentice Hall 1993. Theorem 4.1. Training sequences 0, 3 of set 1 and set 2, in 3GPP TS 45.002 v9.5.0, see tables 5.2.3a and 5.2.3b, have been chosen due to their good cross correlation properties. FIG. 2 shows the power of the estimation error for one user, normalized so that the maximum error has 0 dB variance. FIG. 2 shows the variance of the estimation error for two users. Now there are twice as many taps to estimate, so that the estimation error increases. FIG. 3 shows the variance of the estimation error for 4 users. Not surprisingly, the theoretical error has increased dramatically, since 20=4×5 parameters must be estimated given the same number of received samples. Therefore, it is doubtful whether a single antenna receiver can estimate with sufficient accuracy the channels for 4 simultaneous users. In other words, a straightforward extension of the VAMOS technique in the uplink to more than two users seems unfeasible. There is therefore a need for a technique that can handle more than two users in one slot in the uplink of a radio communication system.

In sum there exists a need for an improved transmission methods and devices for use in radio networks and in particular in radio networks where multiple users are to transmit simultaneously in a single transmission slot.

### SUMMARY

It is an object of the present invention to provide improved methods and devices to address at least some of the problems as outlined above.

This object and others are obtained by the methods and devices as set out in the appended claims.

In accordance with embodiments described herein methods and devices for transmitting and receiving signals that allow accurate channel estimation and synchronization for two or more users that share the same time slot are provided. Moreover, the users may employ Gaussian Minimum Shift Keying (GMSK) (or other non-linear continuous phase modulation techniques), which is well suited for energy efficient transmission.

In accordance with some embodiments methods and devices for training sequence generation and modulation are provided. The methods and devises can in particular be tailored to be suited for Multi User MIMO (MU-MIMO) (Multiple Input Multiple Output, MIMO) scenarios where GMSK modulation (or more generally Continuous Phase Modulation, CPM) is used. Accurate channel estimation can be obtained for several simultaneous users, even with a single antenna receiver.

In accordance with some embodiments a block of bits is processed by, first, block repetition, second, bit flipping and third, frequency shift. By repeating a basic starting block of training bits, and then flipping some of the blocks, a modulated signal (in particular a GMSK modulated signal), when considered in the frequency domain, is forced to utilize only a portion of the available bandwidth. By a judicious choice of the training bit patterns and by appropriately shifting in frequency the continuous time modulated signals, it is possible to ensure that all the user's signals are truly orthogonal in the frequency domain. The term truly orthogonal is used to emphasize that unlike the VAMOS training sequences as described in 3GPP TS 45.002 v9.5.0, perfect orthogonality (in the frequency domain) can be achieved for two or more users.

In accordance with some embodiments a training sequence for a user sharing the same slot with other users is formed, where multiple users are multiplexed in the same time slot. The training sequence for a user is formed by repeating a (original) bit sequence and adding a cyclic prefix and a cyclic postfix to the repeated bit sequence. In accordance with one embodiment the repeated bit sequence will be repeated a number of times corresponding to the number of users in the same time slot. In some embodiments the bits in some sub-blocks of the repeated bit sequence can have the bits flipped. The sub-blocks can correspond to the original bit sequence. The flipping in different sub-blocks can be user specific.

In accordance with some embodiments methods of processing signals to be transmitted are provided. In accordance with some embodiments a transmitter for a user transmitting signals and sharing the same slot with other users, where multiple users are multiplexed in the same time slot is provided. In accordance with some exemplary methods a first, original, block of training symbols and the number of users sharing the same slot is obtained. A block comprising repeated blocks of the first, original, block of training symbols and having a cyclic prefix and a cyclic postfix is formed. The block comprising repeated blocks of the first, original, block of training symbols and having a cyclic prefix and a cyclic postfix is the training sequence for the user.

In accordance with some embodiments a burst to be transmitted is formatted by adding other bits such as tail bits, guard bits, user specific payload bits in a predetermined order to the training sequence for the user. In accordance with one embodiment GSM guard bits are added at the beginning, followed by tail bits, followed by the first half of the payload, then training sequence bits for the user are added, followed by the second half of the payload bits. Finally more tail bits and guard bits are added. In accordance with some embodiments the formatted burst is fed to a modulator. In particular the modulator can be a Continuous Phase Modulator (CPM) modulator. In case of GSM the modulator is typically a GMSK modulator. The output from the modulator is a baseband signal. In accordance with some embodiments a user specific rotation angle, is applied to the baseband signal. The (rotated) baseband signal can be fed to a Radio Frequency (RF) modulator.

In accordance with some embodiments methods for receiver processing are provided. In accordance with one embodiment received samples and a hypothesized synchronization position are obtained. A Discrete Fourier Transform (DFT) is applied to a block of samples corresponding to the training sequence of the received samples. A set of user specific samples is zeroed by means of multiplying the set of user specific samples by zero. An Inverse DFT (IDFT) is applied to the resulting block of samples. In accordance with some embodiments a processed received signal can be used in channel estimation. Also, such a processed received signal with a channel estimate can be fed to a demodulator.

In accordance with some embodiments methods for blind detection are provided. In accordance with some embodiments a received signal is examined and it is determined if training sequences of the received signal are block-repeated. In accordance with one embodiment it is determined if the received training sequence is bit flipped. Depending on the outcome, the received signals are determined to be single layer EGPRS/EGPRS2 or multilayer (MIMO/MU-MIMO).

The invention also extends to a receivers and transmitters arranged to perform the methods as described herein. The receivers and transmitters can be provided with a controller/controller circuitry for performing the above methods. The controller(s) can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor may include, without limitation, digital signal processor (DSP) hardware, ASIC hardware, read only memory (ROM), random access memory (RAM), and/or other storage media.

Other objects and advantages will become apparent from the following detailed description.

### BRIEF DESCRIPTION OF THE DRAWINGS

For a better understanding, reference is made to the following drawings describing different exemplary embodiments and wherein:

FIGS. 1-3 illustrate Cramer-Rao lower bound of the estimation error for a 5-tap channel estimate,

FIG. 4 is a flow chart illustrating steps performed when generating training bits for a user.

FIG. 5 is a flow chart illustrating steps performed when generating training bits for a user

FIG. 6 is a flowchart illustrating processing steps performed in a transmitter,

FIG. 7 is a flowchart illustrating receiver processing for one user,

FIG. 8 is a flowchart illustrating a procedure for blind detection,

FIGS. 9 and 10 illustrate an example with 4 users,

FIG. 11 illustrate the effect of the frequency shift on a signal's spectra,

FIG. 12 is a general view of a transmitter, and

FIG. 13 is a general view of a receiver.

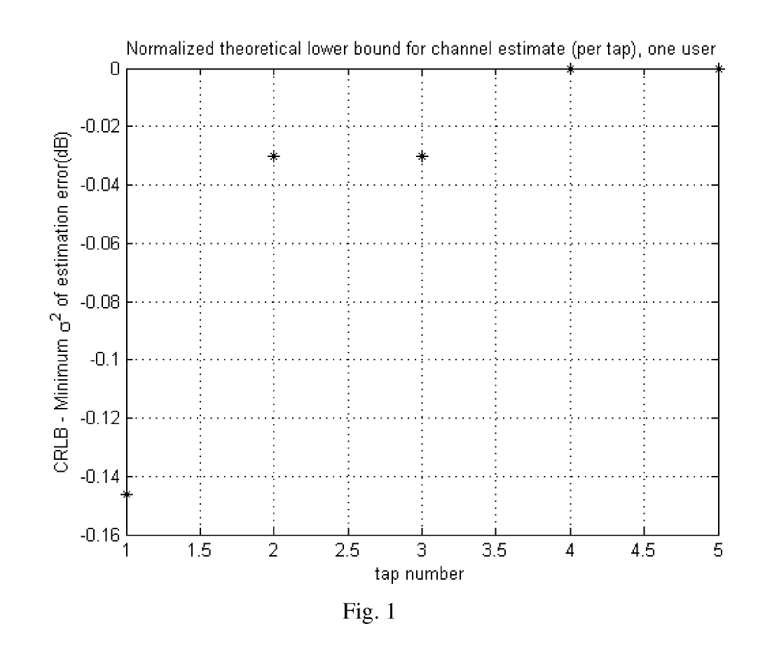

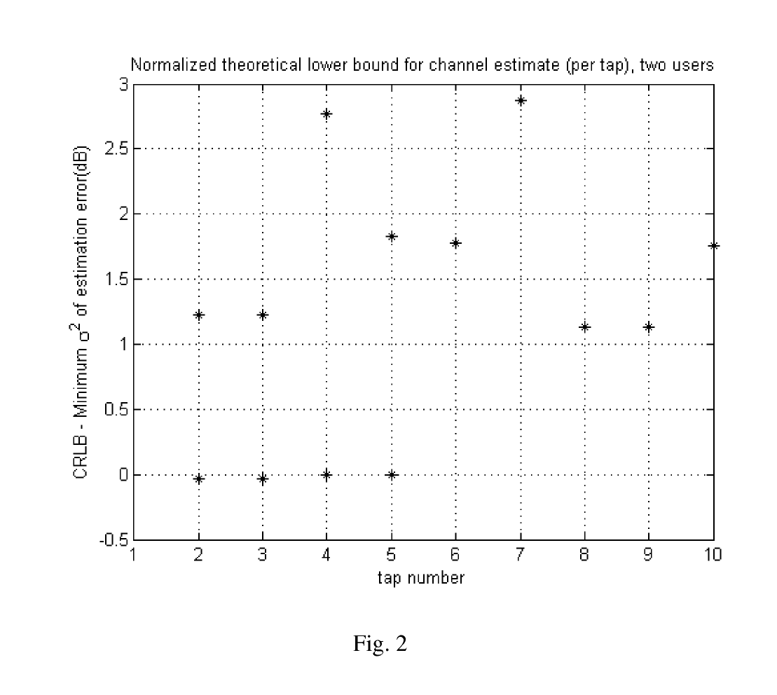

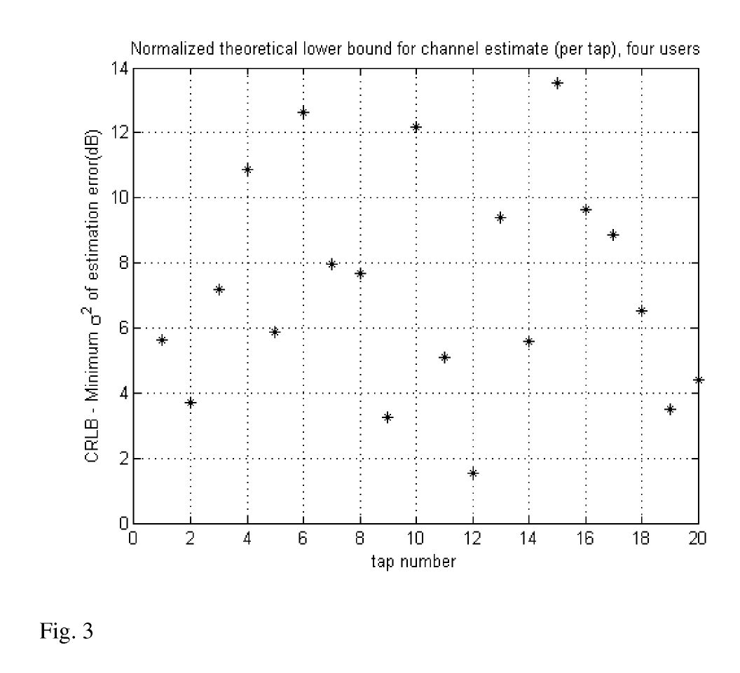

### DETAILED DESCRIPTION

### GMSK Modulation

GMSK is a form of continuous phase modulation. It is defined in 3GPP TS 45.004 as follows. Let \vec{d}={dᵢ}ᵢ₌₁^{N} be a sequence of bits. Each bit dᵢ is differentially encoded. The output of the differential encoder is:

\hat{d}₁=d₁

\hat{d}ᵢ=dᵢ⊕dᵢ₋₁
Where ⊕ denotes modulo 2 addition.

The modulating data value αᵢ input to the modulator is:

αᵢ=1−2\hat{d}ᵢ(αᵢε{−1,+1})

The modulating data values αᵢ as represented by Dirac pulses excite a linear filter with impulse response defined by:

$$g ( t ) = h ( t ) * rect ( \frac{t}{T} )$$

where the function rect(x) is defined by:

$$\begin{matrix}rect ( \frac{t}{T} ) = \frac{1}{T} & for \vert t \vert < \frac{T}{2} \\ rect ( \frac{t}{T} ) = 0 & otherwise\end{matrix}$$

and * means convolution. T is the bit period (=48/13 us in GSM), and h(t) is defined by:

$$h ( t ) = \frac{exp ( \frac{- {t}^{2}}{2 {δ}^{2} {T}^{2}} )}{\sqrt{( 2 π )} \cdot δ T}$$

$$where$$

$$δ = \frac{\sqrt{ln ( 2 )}}{2 π BT}$$

$$and$$

$$BT = 0.3 .$$

The phase of the modulated signal is:

$$ϕ ( {t}^{′} ; {d}^{->} ) = {\sum }_{i} {α}_{i} π h {\int }_{- ∞}^{{t}^{′} - iT} g ( u ) d u$$

where the modulating index h is 1/2 (maximum phase change in radians is π/2 per data interval).

The time reference t′=0 is the start of the active part of the burst. This is also the start of the bit period of bit number 0 (the first tail bit) as defined in 3GPP TS 45.002.

The baseband signal, except for start and stop of the Time Division Multiple Access (TDMA) burst may be expressed as:

x(t′;\vec{d})=exp(j(φ)t′;\vec{d})+φ₀)
where φ₀ is a random phase and is constant during one burst

### DEFINITIONS

A special multiplication operation · will now be defined. Suppose an integer iE{−1,+1} and a (row or column) vector of bits \vec{b}=[b₁, . . . , b_{N}], where bₖ ε{0,1}. The integer i represents a sign. Then define

$$i \cdot {b}^{->} = {b}^{->} \cdot i ≡ [ \frac{1 - i}{2} ⊕ {b}_{1} , \frac{1 - i}{2} ⊕ {b}_{2} , … , \frac{1 - i}{2} ⊕ {b}_{N} ] .$$

In other words, if i is positive then i·\vec{b}=\vec{b}, and if i is negative then i·b is obtained flipping the bits of \vec{b}. Therefore, the operation −1·\vec{b} can referred to as bit flipping. In other words in bit flipping 1's are mapped to 0's and vice versa.

Two Users

First exemplary embodiments with two users will now be described. Two non-equivalent versions will be used.

Training Sequence Generation, First Version

Let Nₜ denote the number of training bits, to be placed as a midamble in a burst to be transmitted. The training bits can be constructed as follows.
1. Select Nₛ training bits \vec{b}=[b(1), . . . ,b(Nₛ)], with 2Nₛ<Nₜ.
2. Form a block repeated sequence \vec{b}ᵣₑₚ=└\vec{b}, \vec{b}┘.
3. Form user specific bit flipped sequences. For user 1, \vec{b}₁^{flip}=[\vec{b}, \vec{b}], and for user 2, \vec{b}₂^{flip}=[\vec{b}, −1·\vec{b}]
4. For each user u=1, 2 extend the rotated repeated sequences periodically, by adding a cyclic prefix and a cyclic postfix. Choose two integers Lₚᵣₑ and Lₚₒₛₜ such that Lₚᵣₑ+Lₚₒₛₜ+2Nₛ=Nₜ. Here Lₚᵣₑ is the length of a cyclic prefix and Lₚₒₛₜ is the length of a cyclic postfix. If L denotes the discrete channel length then Lₚᵣₑ≧L−1. Lₚₒₛₜ should be chosen to be at least as large as the expected time offset between the two signals. The periodically extended training sequences are

$${{v}^{->}}_{u} = [ \underbrace{{{b}^{->}}_{u}^{flip} ( 2 {N}_{s} - {L}_{pre} + 1 ) … {{b}^{->}}_{u}^{flip} ( 2 {N}_{s} )}_{prefix} {{b}^{->}}_{u}^{flip} ( 1 ) … {{b}^{->}}_{u}^{flip} ( 2 {N}_{s} ) \underbrace{{{b}^{->}}_{u}^{flip} ( 1 ) … {{b}^{->}}_{u}^{flip} ( {L}_{post} )}_{postfix} ] , \\ u = 1 , 2.$$

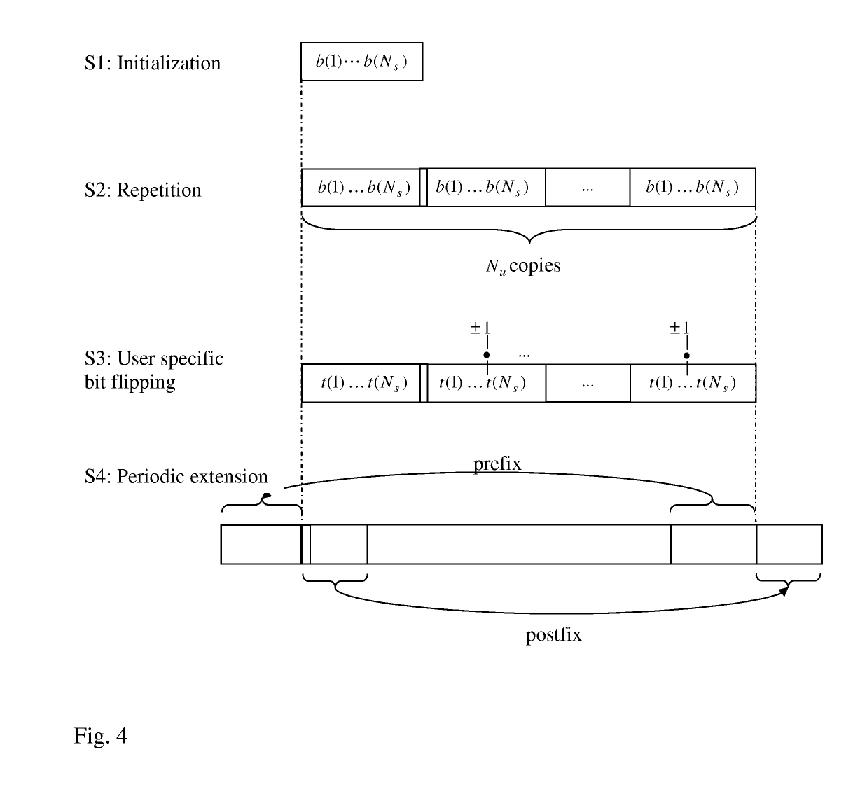

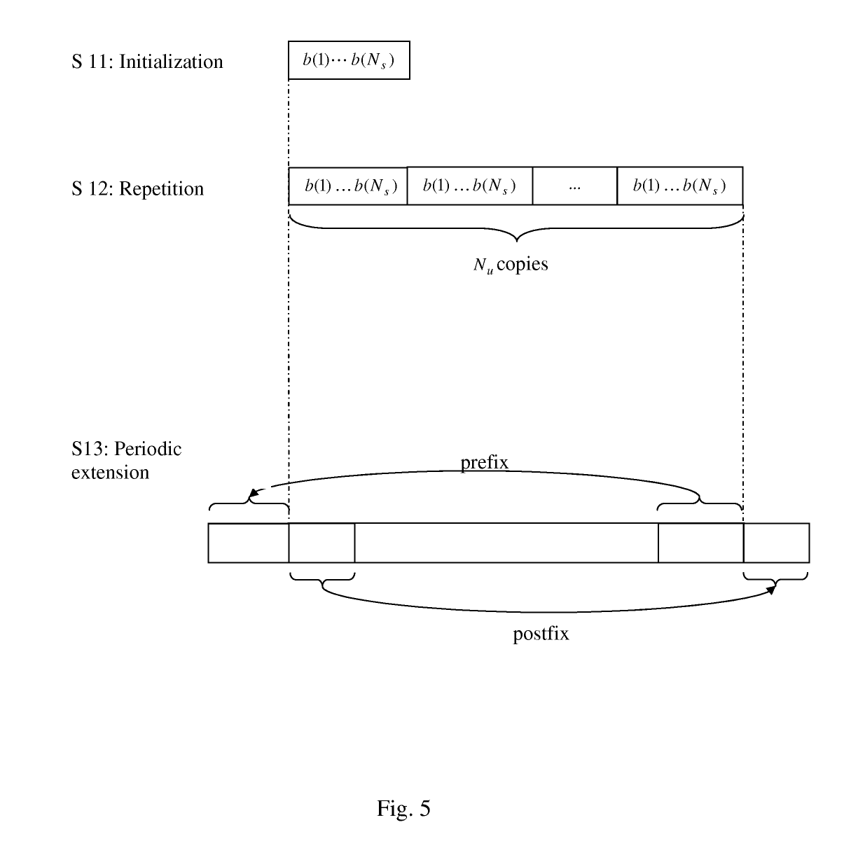

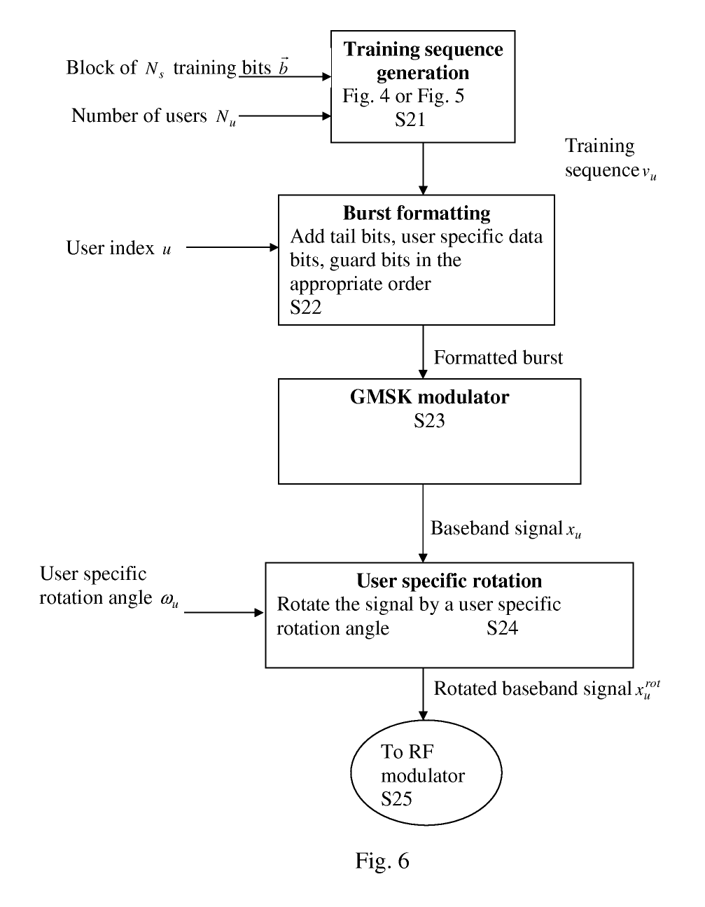

In FIG. 4 a flow chart illustrating some processing steps performed when generating training bits for a user is depicted. FIG. 4 illustrates the generation of training bits for one user. Each user will repeat the same procedure.

First in a step S1, a basic block of training bits is chosen. It may or may not be user specific. It does not matter. In order to be economic it can be assumed that all users employ the same basic block.

Then in a step S2 the basic block of bits is repeated. IN particular the block can be repeated as many times as there are users. For example if four users share the same time slot, then the basic block is repeated 4 times. This generates a repeated block consisting of a number of sub-blocks, where each sub-block is identical to the basic block.

Then in a step S3, a user specific bit flipping is applied to the repeated block. Bit flipping is applied per sub-block. For example, if the second sub-block is to be bit flipped, the all the bits in that sub-block are flipped. (1's are mapped to 0's and vice versa.)

Next, in a step S4 the basic block that has been repeated and flipped sequence of bits (i.e. the output from step S3) is extended periodically. A cyclic prefix and a cyclic postfix are appended at the beginning and at the end.

Training Sequence Generation, Second Version

Let Nₜ denote the number of training bits, to be placed as a midamble in a burst to be transmitted. The training bits can be constructed as follows.
1. Select Nₛ training bits \vec{b}=[b(1), . . . ,b(Nₛ)], with 2Nₛ<Nₜ.
2. Form a block repeated sequence \vec{b}ᵣₑₚ=└\vec{b}, \vec{b}┘,
3. Extend the rotated repeated sequences periodically, by adding a cyclic prefix and a cyclic postfix. Choose two integers Lₚᵣₑ and Lₚₒₛₜ such that Lₚᵣₑ+Lₚₒₛₜ+2Nₛ=Nₜ. Here Lₚᵣₑ is the length of a cyclic prefix and Lₚₒₛₜ is the length of a cyclic postfix. If L denotes the discrete channel length then Lₚᵣₑ≧L−1. Lₚₒₛₜ should be chosen to be at least as large as the expected time offset between the two signals. The periodically extended training sequences are

$${{v}^{->}}_{u} = [ \underbrace{{{b}^{->}}_{rep} ( 2 {N}_{s} - {L}_{pre} + 1 ) … {{b}^{->}}_{rep} ( 2 {N}_{s} )}_{prefix} {{b}^{->}}_{rep} ( 1 ) … {{b}^{->}}_{rep} ( 2 {N}_{s} ) \underbrace{{{b}^{->}}_{rep} ( 1 ) … {{b}^{->}}_{rep} ( {L}_{post} )}_{postfix} ] , \\ u = 1 , 2.$$

Note that both training sequences are identical.

In FIG. 5 a flow chart illustrating some processing steps performed when generating training bits for a user is depicted. FIG. 5 illustrates the generation of training bits for one user. Each user will repeat the same procedure.

First, in a step S11, a basic block of training bits is chosen. It may or may not be user specific. It does not matter. In order to be economic it can be assumed that all users use the same basic block.

Next, in a step S12, the basic block of bits is repeated to form a repeated block. In particular the block can be repeated as many times as there are users For example if four users share the same time slot, then the repeated block can consist of the basic block repeated 4 times.

Then in a step S13 the repeated block repeated sequence is extended periodically. A cyclic prefix and a cyclic postfix are appended at the beginning and at the end.

In general, the output from the training sequence generation process will be a repeated bit sequence having a cyclic prefix and a cyclic postfix. In particular the repeated bit sequence will be repeated a number of times corresponding to the number of users in a slot. Also, in some embodiments the bits in some sub-blocks of the repeated bit sequence will have the bits flipped. The flipping in different sub-blocks can be user specific.

Transmitter, First Version

Now exemplary transmitters will be described. The transmitters can be used for transmitting the training sequences described above.
1. For each user u=1, 2, feed the training sequence \vec{v}ᵤ, to the burst formatter. The burst formatter takes the tail bits, guard bits, user specific data bits and training sequence bits and formats the burst according to a predefined format. For example in GSM tail bits are followed by data bits, the training sequence bits are placed in the middle, followed by more data bits and finally more tail bits. The output is a formatted burst \vec{d}ᵤ containing the training sequence \vec{v}ᵤ as a midamble.
2. For each user u=1, 2, the bit stream \vec{d}ᵤ is fed to a GMSK modulator, such as the GMSK modulator described above. The output of the GMSK modulator is a continuous time baseband signal xᵤ(t′;\vec{d}ᵤ)=exp(j(φ(t′;\vec{d}ᵤ)+φ₀)).
3. The baseband signal is fed to an RF modulator and transmitted.

Remark

A GMSK modulator starts by differentially encoding the input bits, as explained above. If this assumption does not hold, then it will be necessary to change the training sequence generation procedures as described above. However, since it well known that the lack of differential encoding degrades the wireless link performance, the details are omitted here.

In FIG. 6 some processing steps performed in a transmitter are depicted.

FIG. 6 depicts the transmitter for one user. In a deployment scenario it is assumed that all users apply the same transmission method.

First in a step 21a basic block of training symbols and the number of users is obtained. In step 21 It a training sequence having the properties described above is generated. In particular a repeated bit sequence having a cyclic prefix and a cyclic postfix is generated. This can for example be achieved by following the processing steps in accordance with FIG. 4 or FIG. 5. The output from step S21 is the training sequence for the user.

Next, in a step S22 a burst is formatted using the training sequence from step S21. In other words in step S22 an addition of other bits such as tail bits, guard bits, user specific payload bits is performed in a predetermined order. For example in GSM a normal burst normal is formatted as follows, see 3GPP TS 45.002 v9.5.0. Thus, guard bits are added at the beginning, followed by tail bits, followed by the first half of the payload, and then training sequence bits are added, followed by the second half of the payload bits. Finally more tail bits and guard bits are added.

Next, in a step S23, the formatted burst is fed to a modulator. In particular the modulator can be a CPM modulator. In case of GSM the modulator is typically a GMSK modulator (see above). The output is the modulated baseband signal.

Next, in a step S24 a rotation angle, in particular a user specific rotation angle, is applied to the baseband signal. This step may not be performed for all types of signals.

Then, in step S25, the (rotated) baseband signal is fed to a Radio Frequency (RF) modulator.

Transmitter, Second version

Assuming that the training sequences were generated according to the second version of generating a training sequence as set out above, the following exemplary transmitter processing can be applied.
1. For each user u=1, 2, feed the training sequence \vec{v}ᵤ to the burst formatter. The burst formatter takes the tail bits, guard bits, user specific data bits and training sequence bits and formats the burst according to a predefined format. For example in GSM tail bits are followed by data bits, the training sequence bits are placed in the middle, followed by more data bits and finally more tail bits. The output is a formatted burst \vec{d}ᵤ containing the training sequence \vec{v}ᵤ as a midamble.
2. For each user u=1, 2, the bit streams are fed to a GMSK modulator, described above. The output of the GMSK modulator is a continuous time baseband signal xᵤ(t′;\vec{d}ᵤ)=exp(j(φ(t′;\vec{d}ᵤ)+φ₀)).
3. The continuous time baseband signal is rotated by a user specific angle. Let T be the bit duration (=48/13 us in GSM). Then the rotation angle is of the form

$${ω}_{u} = \frac{2 π \cdot u}{{N}_{u} {N}_{s} T} + \frac{2 π \cdot {ψ}_{0}}{T} ,$$

where ψ₀ is a fixed but otherwise arbitrary angle.
The rotated baseband signal is

xᵤ^{rot}(t′;\vec{d}ᵤ)=exp(j(φ(t′;\vec{d}ᵤ)+φ₀))·exp(jωᵤt′).
4. The rotated baseband signal is fed to an RF modulator and transmitted.

The steps above can be processed in accordance with the processing steps described in FIG. 6.

Properties of the Modulated Signals

The training sequence generation method in accordance with the examples given in the first version, used together with the transmitter given in the first version, generates signals that are completely orthogonal in the frequency domain. Specifically, block repetition and user specific bit flipping, followed addition of cyclic prefix and suffix, create GMSK signals that are orthogonal in the frequency domain, provided the signals are restricted to the training sequence. Orthogonality is preserved even if there is some jitter which causes some signals to arrive earlier or later than the others. Similarly, the signals generated in the second version of training sequence generation and the second version of a transmitter is orthogonal in the frequency domain. However, in this method it is typically necessary to shift the whole signal for the second user in the frequency domain in order to achieve orthogonality between the two users.

Four Users

To exemplify how a training sequence for four users can be obtained and transmitted, two versions of training sequence generation and of a transmitter will be described below.

Training Sequence Generation, Third Version

Let Nₜ denote the number of training bits, to be placed as a midamble in the burst. Assume that there are Nᵤ=4 users. The training bits can be constructed as follows.
1. Select Nₛ training bits \vec{b}=[b(1), . . . ,b(Nₛ)], with Nᵤ·Nₛ<Nₜ.
2. Form a block repeated sequence \vec{b}ᵣₑₚ=[\vec{b}, \vec{b}, \vec{b}, \vec{b}].
3. Form user specific bit flipped sequences. These are denoted \vec{b}ᵤ^{flip}, u=1, . . . 4. They are defined as follows.

\vec{b}₁^{flip}=[\vec{b},\vec{b},\vec{b},\vec{b}],

\vec{b}₂^{flip}=[\vec{b},\vec{b},\vec{b},\vec{b}],

\vec{b}₃^{flip}=[\vec{b},−1·\vec{b},\vec{b},−1\vec{b}],

\vec{b}₄^{flip}=[\vec{b},−1·\vec{b},\vec{b},−1·\vec{b}].
4. For each user u=1, . . . ,4 extend the rotated repeated sequences periodically, by adding a cyclic prefix and a cyclic postfix. Choose two integers Lₚᵣₑ and Lₚₒₛₜ such that Lₚᵣₑ+Lₚₒₛₜ+NᵤNₛ−Nₜ. Here Lₚᵣₑ is the length of a cyclic prefix and Lₚₒₛₜ is the length of a cyclic postfix. If L denotes the discrete channel length then Lₚᵣₑ≧L−1. Lₚₒₛₜ can be chosen to be at least as large as the expected time offset between the two signals. The periodically extended training sequences are

$${{v}^{->}}_{u} = [ \underbrace{{{b}^{->}}_{u}^{flip} ( {N}_{u} {N}_{s} - {L}_{pre} + 1 ) … {{b}^{->}}_{u}^{flip} ( {N}_{u} {N}_{s} )}_{prefix} {{b}^{->}}_{u}^{flip} ( 1 ) … {{b}^{->}}_{u}^{flip} ( {N}_{u} {N}_{s} ) \underbrace{{{b}^{->}}_{u}^{flip} ( 1 ) … {{b}^{->}}_{u}^{flip} ( {L}_{post} )}_{postfix} ] , \\ u = 1 , … , 4.$$

Training Sequence Generation, Fourth Version

Let Nₜ denote the number of training bits, to be placed as a midamble in the burst. Assume that there are Nᵤ=4 users. The training bits can be constructed as follows.
1. Select Nₛ training bits \vec{b}=[b(1), . . . , b(Nₛ)], with Nᵤ·Nₛ<Nₜ.
2. Form a block repeated sequence \vec{b}ᵣₑₚ=└\vec{b}, \vec{b}, \vec{b}, \vec{b},
3. Extend the rotated repeated sequences periodically, by adding a cyclic prefix and a cyclic postfix. Choose two integers Lₚᵣₑ and Lₚₒₛₜ such that Lₚᵣₑ+Lₚₒₛₜ+NᵤNₛ=Nₜ. Here Lₚᵣₑ is the length of a cyclic prefix and Lₚₒₛₜ is the length of a cyclic postfix. If L denotes the discrete channel length then Lₚᵣₑ≧L−1. Lₚₒₛₜ should be chosen to be at least as large as the expected time offset between the two signals. The periodically extended training sequences are

$${{v}^{->}}_{u} = [ \underbrace{{{b}^{->}}_{rep} ( {N}_{u} {N}_{s} - {L}_{pre} + 1 ) … {{b}^{->}}_{rep} {N}_{u} {N}_{s} )}_{prefix} {{b}^{->}}_{rep} ( 1 ) … {{b}^{->}}_{rep} ( {N}_{u} {N}_{s} ) \underbrace{{{b}^{->}}_{rep} ( 1 ) … {{b}^{->}}_{rep} ( {L}_{post} )}_{postfix} ] , \\ u = 1 , … , 4.$$

Note that all training sequences are identical.

Transmitter, Third Version

Now an exemplary transmitter that can be used to transmit a signal having a training sequence generated according to the method described above for the third version.
1. For each user u=1, . . . ,4, feed the training sequence \vec{v}ᵤ to the burst formatter. The burst formatter takes the tail bits, guard bits, user specific data bits and training sequence bits and formats the burst according to a predefined format. For example in GSM tail bits are followed by data bits, the training sequence bits are placed in the middle, followed by more data bits and finally more tail bits. The output is a formatted burst \vec{d}ᵤ containing the training sequence \vec{v}ᵤ as a midamble.
2. For each user u=1, . . . , 4, the bit stream \vec{d}ᵤ is fed to a modulator such as a GMSK modulator, described above. The output of a GMSK modulator is a continuous time baseband signal xᵤ(t′;\vec{d}ᵤ)=exp(j(φ(t′;\vec{d}ᵤ)+φ₀)).
3. The continuous time baseband signal is rotated by a user specific angle. Let T be the bit duration (=48/13 us in GSM). Then the rotation angle is of the form

$${ω}_{u} = \{ \begin{matrix}\frac{2 π}{{N}_{u} {N}_{s} T} + \frac{2 π \cdot {ψ}_{0 ,}}{T} & u = 2 , 4 \\ \frac{2 π \cdot {ψ}_{0 ,}}{T} , & u = 1 , 3\end{matrix}$$

where ψ₀ is a fixed but otherwise arbitrary angle.
   The rotated baseband signal is

xᵤ^{rot}(t′,\vec{d}ᵤ)=exp(j(φ(t′;\vec{d}ᵤ)+φ₀))·exp(jωᵤt′).
4. The baseband signal is fed to an RF modulator and transmitted.
   The transmitter processing can be performed in accordance with the steps described in conjunction with FIG. 6.

Properties of the Modulated Signals

The training sequence generation method in accordance with the examples given in the third version, used together with the transmitter given in the third version, generates signals that are completely orthogonal in the frequency domain. Specifically, block repetition and user specific bit flipping, followed addition of cyclic prefix and suffix, create GMSK signals that are orthogonal in the frequency domain, provided the signals are restricted to the training sequence. Orthogonality is preserved even if there is some jitter which causes some signals to arrive earlier or later than the others. Similarly, the signals generated in the fourth version of training sequence generation and the fourth version of a transmitter is orthogonal in the frequency domain. However, in this method it is typically necessary to shift the signals in the frequency domain in order to achieve orthogonality among all users.

Transmitter, Fourth Version

The transmitter is identical to the transmitter described above for the third version, except that u=1, . . . ,4 and Nᵤ=4.

Description of Exemplary Receivers

The below examples are restricted to the case of one receive antenna. This is typically the most challenging case for multi-user detection. Extensions to two or more antennas are straightforward. It is assumed that the transmitted signal is modulated using a GMSK modulator. Let r(n) denote the received digital signal after de-rotation by π/2. Using the Laurent decomposition of GMSK (assuming the bandwidth-time product BT≧0.3), and it can be modeled as

$$\tilde{r} ( n ) = {\sum }_{u = 1}^{{N}_{u}} {\sum }_{k = 0}^{{L}_{u} - 1} {h}_{u} ( k ) {s}_{u} ( n - k + {m}_{u} ) + w ( n )$$

for all n, where w(n) denotes the noise, hᵤ(k) denotes the channel to or from user, depending on whether it is for uplink or downlink communication, Lᵤ denotes the number of taps in hᵤ(k), sᵤ(n) are Binary phase-shift keying (BPSK) symbols corresponding to the modulating bits for user u, and mᵤ is the relative timing offset among the users. Without loss of generality it can be assumed that 0≦mᵤ≦Lₚₒₛₜ and Lᵤ=L. Assume that w(n)˜N(0,σ_{w}²), and that all hᵤ(k) remain unchanged over each burst. The received signal model applies to both uplink and downlink. The training sequence bits are mapped to BPSK symbols through the linearization of GMSK: tᵤ(n)=1−2vᵤ(n).

The received signal can first be de-rotated by ψ₀. Recall that this was an arbitrary rotation angle introduced at the transmitter as described above.

r(n)=\tilde{r}(n)·exp(−j2π·nψ₀).

Let n₀ be the hypothesized synchronization position and let

$$R ( {n}_{0} ) ≡ [ \begin{matrix}r ( {n}_{0} + L ) \\ r ( {n}_{0} + L + 1 ) \\ ⋮ \\ r ( {n}_{0} + L + {N}_{u} {N}_{s} - 1 )\end{matrix} ]$$

be the vector of received samples over the training sequences. The matrix F shall denote the Discrete Fourier Transform (DFT) matrix. Compute the discrete Fourier transform Zₙ_{₀}=F·R(n₀). In order to obtain the channel estimate for user u, zero all the entries of Zₙ_{₀} except those with indices

ρ(u),ρ(u)+Nᵤ,ρ(u)+2Nᵤ, . . . ,ρ(u)+(Nₛ−1)Nᵤ,
where ρ(u) is an integer index defined in Table 1.

TABLE 1
Index for user u, according to Tx

| | | Transmitter version |
|---|---|---|
| u | ρ(u) | number |
| 1 | 2 | 1 |
| 2 | 1 | 1 |
| 1 | 1 | 2 |
| 2 | 2 | 2 |
| 1 | 4 | 3 |
| 2 | 1 | 3 |
| 3 | 2 | 3 |
| 4 | 3 | 3 |
| 1 | 1 | 4 |
| 2 | 2 | 4 |
| 3 | 3 | 4 |
| 4 | 4 | 4 |

In other words, set

Zₙ_{₀}^{u}≡[0 . . . 0 Zₙ_{₀}(ρ(u))0 . . . 0 Zₙ_{₀}(ρ(u)+Nᵤ)0 . . . 0 Zₙ_{₀}(ρ(u)+2Nᵤ)0 . . . ]^{T}

The periodicity of the training sequences (due to the cyclic prefix and postfix) implies that the received signal can be obtained by circular convolution of the channel and the transmitted Binary Phase Shift Keying (BPSK) symbols in the Laurent linear approximation of GMSK.

Define the DFT of the Noise Vector

W≡DFT{[w(n₀+L), . . . ,w(n₀+L+NᵤNₛ−1)]}
and apply the Inverse Discrete Fourier Transform (IDFT) to obtain

\vec{z}ᵤ≡F_{H}·Zₙ_{₀}^{u}=Cᵤ·[tᵤ(Lₚᵣₑ+1+mᵤ), . . . , tᵤ(Lₚᵣₑ+NᵤNₛ+mᵤ)]^{T}+IDFT{[0 . . . 0W(ρ(u))0 . . . 0W(ρ(u)+Nᵤ)0 . . . 0W(ρ(u)+NₛNᵤ)0 . . . ]}^{T}.

Here, Cᵤ is a circulant matrix whose non-zero entries are exactly the channel coefficients hᵤ(0), . . . , hᵤ(L−1), the noise power has been reduced by 10 log₁₀(Nᵤ)dB, the color of the noise is preserved, and the contribution to the received signal of all users except user u has been eliminated. This provides a single user linear model from which hᵤ(0), . . . , hᵤ(L−1) can be estimated using any algorithm chosen among the plethora of linear estimation algorithms, such as least squares or Minimum mean-square error (MMSE).

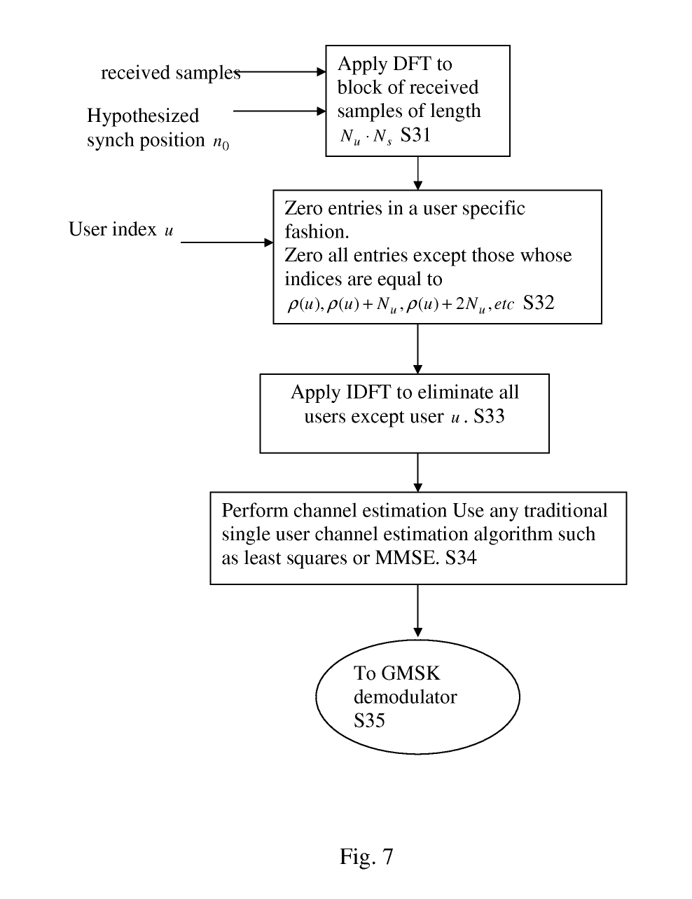

A flow chart illustrating some receiver processing steps is shown in FIG. 7.

FIG. 7 illustrates receiver processing for one user. The receiver can be adapted to perform the same process for every user.

First, in a step S31, received samples and a hypothesized synchronization position are obtained. Then a DFT is applied to a block of samples corresponding to the training sequence. These frequency domain samples are output to the next step S32.

In step S32, a set of user specific samples is zeroed. To zero a sample means to multiply it by zero. The frequency domain block with some samples zeroed is output to a subsequent step S33. In particular the following rule can be used when zeroing samples. Every N_u, where N_u is the number of users/layers, samples are not zeroed, starting at an offset that is user specific. For example, assume there are N_u=4 users and the interest is with user#3. Assume that the user specific offset for user#3 is 2 where the offset depends on the transmitter version. Then the samples 2, 2+4, 2+4*2, 2+4*3, etc. are NOT zeroed. All other samples are zeroed

In step S33, an IDFT is applied. This gives a time domain signal where the energy from all other users (over the training sequence only) has been eliminated. Moreover application of the IDFT also increases the Signal to Noise Ratio (SNR) since the noise contribution from the zeroed samples is eliminated.

Next, in a step S34, the signal from step S33, i.e. a single user time domain signal, is processed. In step S34 a channel estimation is performed. Any algorithm for channel estimation can be applied. There are many well known algorithms in the art, such as Least Squares or Minimum Mean Square Error estimators.

Finally, in a step S35, having found the channel estimate, the signal is fed to a demodulator. In particular any ordinary (single user) GMSK demodulator can be used. Demodulation is outside of the scope of the description provided herein.

Spectra of the Transmitted Signals

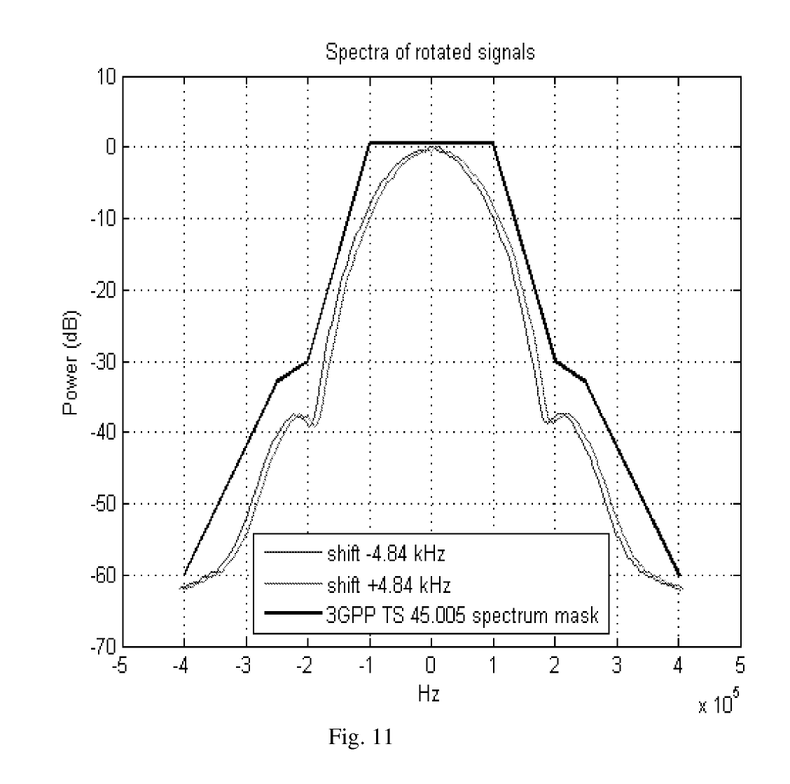

A rotation by a user specific rotation angle ωᵤ introduces a shift in the power spectrum of the transmitted signal. The arbitrary rotation angle ψ₀ has been introduced in order to minimize the total spread of the transmitted signals around the nominal center of frequency. FIG. 11 shows the effect of the frequency shift on the signal's spectra. The GSM transmission mask for the Mobile Station (MS) is also shown. In this example Nᵤ=4, Nₛ=7, T=3.69 μs, so that

$$\frac{1}{{N}_{u} {N}_{T} T} = 9.68 kHz .$$

By choosing

$$\frac{{ψ}_{0}}{T} = - 4.84 kHz$$

it is ensured that two of the carriers will have their spectra shifted −4.84 kHz with respect to the center of frequency, while the other two carriers will have their spectra shifted +4.84 kHz from the center of frequency. Note that GMSK modulated signals shifted by 4.84 kHz are well within the GSM spectrum mask defined in 3GPP TS 45.005 for GMSK modulated signals, as illustrated in FIG. 11.

### EXAMPLE

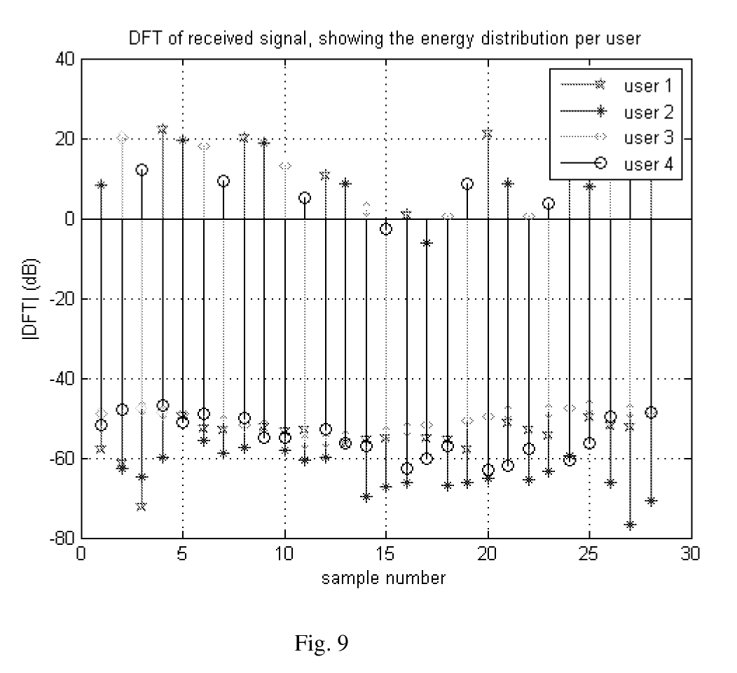

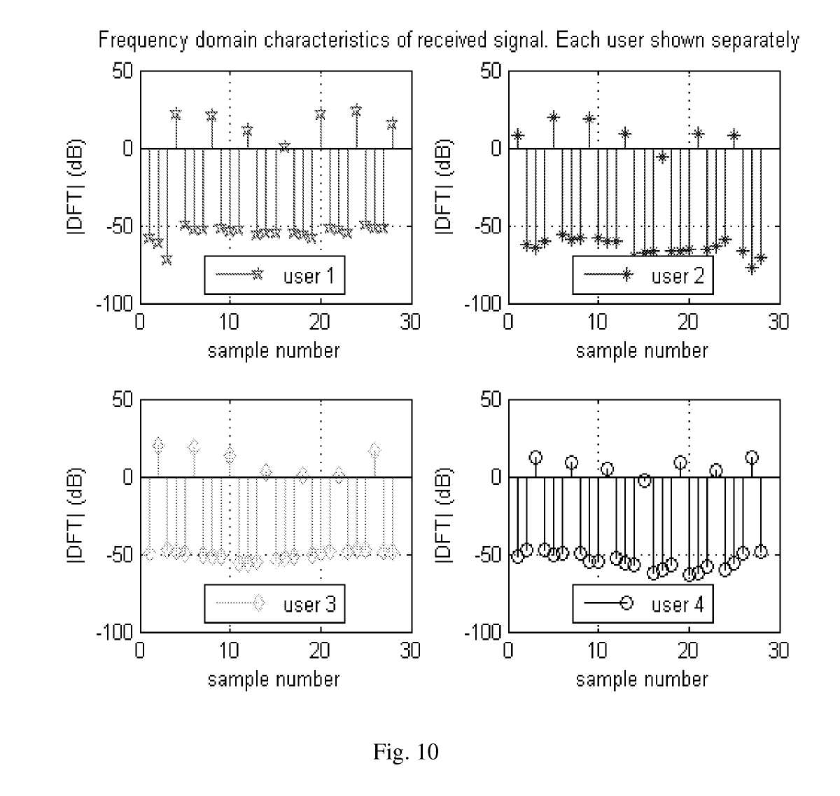

The methods described above will now be illustrated by means of an example. FIG. 9 and FIG. 10 illustrate the case of 4 users; Nᵤ=4,Nₛ=7.

FIG. 9 shows the received signal (over training sequence) in the frequency domain with a Typical Urban (TU) TU3 propagation model.

FIG. 10 shows the received signal (over the training sequence) in the frequency domain, TU3 propagation. The contribution from each user is shown separately. The received signal is the superposition of all individual signals.

The signals have been generated and modulated according to the methods described in conjunction with the third version of training sequence generation and the third version of a transmitter. The signals undergo independent Rayleigh fading according to a Typical Urban 3 km/h propagation model. The digital signal has been downsampled to one sample per bit period. The frequency domain characteristics of the digital received signals are shown separately for each user. The actual received signal is the superposition of the 4 user's signals. It can be seen that
The energy of each signal is concentrated on a subset of the sub-carriers in the frequency domain.
For practical purposes, the sub-carriers corresponding to different users do not overlap.
   Therefore, each user can be completely separated by applying the Discrete Fourier Transform, zeroing the sub-carriers where the energy of the other users is concentrated, and getting back to the time domain via the Inverse Discrete Fourier Transform.

### Generalizations

The following generalizations of the techniques disclosed above are straightforward.
The number of users Nᵤ can be chosen arbitrarily.
The basic block of bits \vec{b} may be chosen to be user specific. Block repetition, user specific bit flipping and user specific rotation of the baseband signal will ensure that the received signals have orthogonal spectra over the training sequence. Here the word orthogonality is used in the sense that the energy in the DFT of the signals is concentrated on non-overlapping frequencies. Therefore, over the training sequence, the users are separated in the frequency domain.
Other type of Continous Phase Modulation (CPM) may be used in lieu of GMSK.

GMSK signals with small bandwidth-time product

The receiver described above is based upon a linear model of the received signal. This linear model can be based on the Laurent decomposition of GMSK with bandwidth-time product BT≧0.3. However, the training sequence generation and modulation techniques described herein do not rely in any way on the approximate linearity of GMSK, which is valid when BT≧0.3. The same techniques can be applied to highly non-linear variants of GMSK modulation with small bandwidth-time product BT<0.3. The user's signals are still orthogonal in the frequency domain, when restricted to the training sequence.

Blind Detection

In EGPRS/EGPRS2 (EDGE and GPRS, General Packet Radio Services) the modulation type is unknown at the receiver. However, it is implicitly signaled by applying different rotations to the training symbols. Each modulation (e.g. 8PSK, 16QAM) has its own, unique rotation angle. The process of discovering the modulation type of the signal is known as blind detection.

The blind detection of EGPRS/EGPRS2 can be configured to include also signals whose training sequence has been created using the block repetition technique described herein. This is useful because it allows users to adaptively switch between single layer EGPRS/EGPRS2 and MIMO/MU-MIMO modes depending on the radio channel conditions or the signaling needs.

The training sequences described herein have the following property that is not shared by the EGPRS/EGPRS2 training sequences.
The new training sequences consist of block repeated bits, possibly bit flipped.

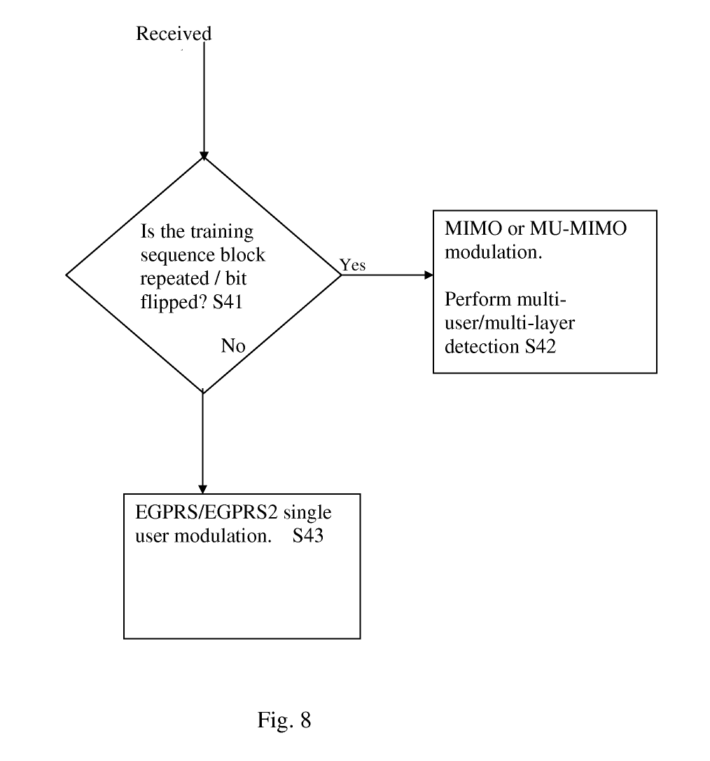

This property is enough to blindly detect the modulation type at the receiver. A procedure for blind detection is depicted in FIG. 8.

In FIG. 8 a blind detection procedure for signals modulated according to the principles described herein is illustrated.

First in a step S41, a received signal is examined and it is determined if the training sequences are block-repeated. In accordance with one embodiment it is also determined if the received training sequence is bit flipped. The EGPRS training sequences do not have (any) of these properties.

This can be accomplished by using the method described above in conjunction with FIG. 7 to each user and determining how good is the fit.

Depending on the outcome, the signals are determined to be single layer EGPRS/EGPRS2 or multilayer (MIMO/MU-MIMO). Thus, if the training sequences are block-repeated and possibly also bit flipped the signals are determined to be multilayer in a step S42. If the training sequences are not block-repeated the signals are determined to be single layer EGPRS/EGPRS2.

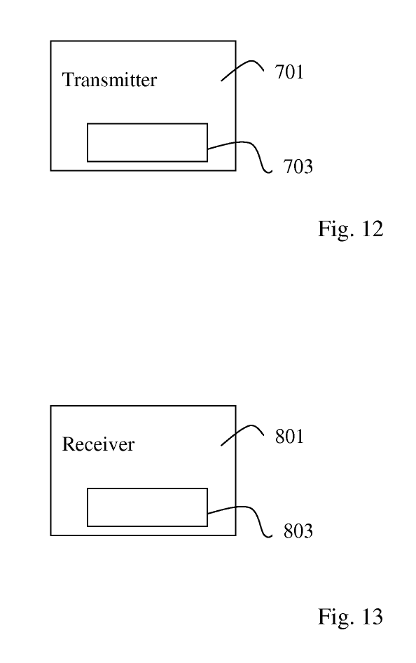

FIG. 12 depicts a transmitter 701 for generating and transmitting signals as described herein. The transmitter can be implemented in a mobile station. The transmitter 701 comprises controller circuitry 703 for performing the various steps required when forming a signal for transmission in accordance with the principles described herein. The controller circuitry can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media.

FIG. 13 depicts a receiver 701 for receiving and processing received signals as described herein. The receiver can be implemented in a radio base station. The receiver 301 comprises controller circuitry 703 for performing the various steps required when receiving signals in accordance with the principles described herein. The controller circuitry can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media.

Using the transmission methods and devices as described herein provides advantages over existing transmission methods. For example in accordance with some embodiments It is possible to perfectly separate, detect, synchronize and estimate the channels for multiple users user, even with a single antenna receiver.

Some embodiments will pose modest computational requirements at the receiver side. Joint detection is not necessary.

Some embodiments are possible to apply to highly non-linear modulations such as GMSK with small bandwidth-time product or other forms of CPM.

More generally, the training sequence design described herein can be useful in GSM/EDGE for MIMO or MU-MIMO scenarios, since it allows simple and accurate multi-user detection of GMSK modulated signals.

Finally, it is to be noted that other implementations than those specifically set forth herein can of course be formed without departing from essential characteristics of the described methods and devices. The present embodiments are to be considered in all respects as illustrative and not restrictive. In particular the teachings herein are applicable for a mobile station (or radio base station) in a single user Multiple Input Multiple Output (MIMO) mode. In a single user MIMO mode there is just one mobile station transmitting in the transmission slot, but there are several layers (users) transmitted in each transmission slot. Each layer is a data stream sent through a different transmit antenna. The methods and devices as described herein can thus be applied to two (or more) mobile stations, each having one transmit antenna, and it can equally well be applied to one mobile station having two (or more) transmit antennas, when the one mobile station is transmitting in single user MIMO mode. In both these scenarios there will be two different data streams, two training sequences and two antennas (in the case of two users in the same transmission slot).

More generally it is possible to have one mobile station with 4 transmit antennas, 2 mobile stations each with 2 transmit antennas, 4 mobile stations each with one transmit antenna, and so on. The generation of 4 training sequences is identical in all cases: In the case of 4 transmitting antennas there are 4 orthogonal training sequences.

In accordance with yet one exemplary implementation one layer or data stream can be sent via multiple transmit antennas. In such an implementation the number of training sequences corresponds to the total number of layers or data streams transmitted in the same transmission slot. For example, two layers or data streams and two orthogonal training sequences can be sent through 4 transmit antennas, but sending exactly the same data stream through two Tx antennas.

1-32. (canceled)

33. A method of generating a training sequence in a radio communication network for a user sharing the same transmission slot with other users, where multiple users are multiplexed in the same time slot, the method comprising:
repeating one or more times a first, original, bit sequence; and
adding a cyclic prefix and a cyclic postfix to the repeated bit sequence, thereby forming the training sequence for the user.

34. The method of claim 33, wherein the repeated bit sequence is repeated a number of times corresponding to the number of users in the same time slot.

35. The method of claim 33, wherein the bits in some sub-blocks of the repeated bit sequence are bit flipped.

36. The method of claim 35, wherein the sub-blocks correspond to the original bit sequence.

37. The method of claim 35, wherein the flipped bits are user specific.

38. The method of claim 33, further comprising formatting a burst to be transmitted by adding other bits in a predetermined order to the training sequence for the user.

39. The method of claim 38, wherein said other bits comprise one or many of tail bits, guard bits, and user specific payload bits.

40. The method of claim 39, wherein the burst is formatted by adding GSM guard bits at the beginning, followed by tail bits, followed by a first half of the payload, then training sequence bits for the user are added, followed by a second half of the payload bits followed by more tail bits and guard bits.

41. The method of claim 38, further comprising feeding the burst to a modulator.

42. The method of claim 41, wherein the modulator is a Continuous Phase Modulator (CPM) modulator.

43. The method of claim 42, wherein the modulator is a GMSK modulator.

44. The method of claim 41, further comprising rotating an output signal from the modulator with a user specific rotation angle.

45. A method for processing a received signal, the method comprising:
receiving samples of the signal,
obtaining a hypothesized synchronization position of the signal,
applying a Discrete Fourier Transform (DFT) to a block of received samples corresponding to a training sequence.
zeroing a set of user specific samples by multiplying the set of user specific samples by zero.
applying an Inverse DFT (IDFT) to the resulting block of samples after a zeroing has been performed.

46. The method of claim 45, further comprising generating a channel estimation based on the processed received signal.

47. The method of claim 46, wherein the processed received signal together with the channel estimate is fed to a demodulator.

48. A method of blind detection of a received GSM radio signal, the method comprising:
determining in a first determination step whether training sequences of the received signal are block-repeated, or determining whether the received training sequence is block-repeated and bit flipped; and
detecting the received GSM signal as a single layer EGPRS/EGPRS2 or multilayer (MIMO/MU-MIMO) signal based on the outcome in said first determination step.

49. A device for generating a training sequence in a radio communication network for a user sharing the same transmission slot with other users, where multiple users are multiplexed in the same time slot, the device comprising:
controller circuitry for repeating one or more times a first, original, bit sequence, and
controller circuitry for adding a cyclic prefix and a cyclic postfix to the repeated bit sequence thereby forming the training sequence for the user.

50. The device of claim 49, wherein the controller circuitry is adapted to repeat the repeated bit sequence a number of times corresponding to the number of users in the same time slot.

51. The device of claim 49, wherein the controller circuitry is adapted to bit flip the bits in some sub-blocks of the repeated bit sequence.

52. The device of claim 51, wherein the sub-blocks correspond to the original bit sequence.

53. The device of claim 51, wherein the flipped bits are user-specific.

54. The device of claim 49, wherein the controller circuitry is adapted to format a burst to be transmitted by adding other bits in a predetermined order to the training sequence for the user.

55. The device of claim 54, wherein said other bits comprise one or many of tail bits, guard bits, and user specific payload bits.

56. The device of claim 55, wherein the controller circuitry is adapted to format the burst by adding GSM guard bits at the beginning, followed by tail bits, followed by a first half of the payload, then training sequence bits for the user are added, followed by a second half of the payload bits followed by more tail bits and guard bits.

57. The device of claim 54, further comprising a modulator adapted to receive the formatted burst.

58. The device of claim 57, wherein the modulator is a Continuous Phase Modulator (CPM) modulator.

59. The device of claim 58, wherein the modulator is a GMSK modulator.

60. The device of claim 57, further comprising a rotator for rotating an output signal from the modulator with a user specific rotation angle.

61. A device for processing a received signal, the device comprising:
controller circuitry adapted to receive samples of the signal,
controller circuitry adapted to obtain a hypothesized synchronization position of the signal,
controller circuitry adapted to applying a Discrete Fourier Transform (DFT) to a block of received samples corresponding to a training sequence.
controller circuitry adapted to zero a set of user specific samples by multiplying the set of user specific samples by zero.
controller circuitry adapted to apply an Inverse DFT (IDFT) to the resulting block of samples after a zeroing has been performed.

62. The device of claim 61, further comprising controller circuitry adapted to generate a channel estimation based on the processed received signal.

63. The device of claim 62, further comprising controller circuitry adapted to feed the processed received signal together with the channel estimate to a demodulator.

64. A device for blind detection of a received GSM radio signal, the device comprising:
controller circuitry adapted to determine in a first determination step whether training sequences of the received signal are block-repeated, or determining whether the received training sequence is block-repeated and bit flipped; and
controller circuitry adapted to detect the received GSM signal as a single layer EGPRS/EGPRS2 or multilayer (MIMO/MU-MIMO) signal based on the outcome in said determination step.
